(19) United States
(12) Patent Application Publication
(10) Pub. No.: US 2021/0374541 A1
(43) Pub. Date: Dec. 2, 2021

(54) INFORMATION PROCESSING METHOD AND RECORDING MEDIUM

(71) Applicant: Panasonic Intellectual Property Corporation of America, Torrance, CA (US)

(72) Inventor: Yasunori ISHII, Osaka (JP)

(21) Appl. No.: 17/404,312

(22) Filed: Aug. 17, 2021

Related U.S. Application Data
(63) Continuation of application No. PCT/JP2020/015801, filed on Apr. 8, 2020.
(60) Provisional application No. 62/854,673, filed on May 30, 2019.

(30) Foreign Application Priority Data
Dec. 20, 2019 (JP) 2019-229945

(51) Int. Cl. G06N 3/08; G06N 3/04

(52) U.S. Cl. CPC G06N 3/08; G06N 3/04

(57) ABSTRACT

In an information processing method to be executed by a computer, with a first model trained through machine learning to output data simulating noise-reduced data in response to input noise-containing data, feature data of first data generated by the first model generated via processes leading up to output of second data simulating noise-reduced first data of input noise-containing first data is obtained; this feature data is input to a second model that is an estimation model, and inference result data that the second model outputs in response to an input of the feature data is obtained; and the second model is trained through machine learning based on the inference result data and reference data that is for making inference about the first data.

### CROSS REFERENCE TO RELATED APPLICATIONS

This is a continuation application of PCT International Application No. PCT/JP2020/015801 filed on Apr. 8, 2020, designating the United States of America, which is based on and claims priority of U.S. Provisional Patent Application No. 62/854,673 filed on May 30, 2019 and Japanese Patent Application No. 2019-229945 filed on Dec. 20, 2019. The entire disclosures of the above-identified applications, including the specifications, drawings and claims are incorporated herein by reference in their entirety.

### FIELD

The present disclosure relates to an information processing method to be executed by a computer.

### BACKGROUND

Techniques related to a reconstructing process of reconstructing an image (hereinafter, a pre-reconstruction image) based on the feature amount of this pre-reconstruction image are being studied (see, for example, Non Patent Literature 1). In one conceivable case, for example, an image reconstructed through a reconstructing process may be subjected to image recognition, and this may indirectly yield the result of image recognition that would be obtained from the image recognition performed on the pre-reconstruction image.

### CITATION LIST

### Non Patent Literature

NPL 1: Diederik P. Kingma and Max Welling, “Auto-Encoding Variational Bayes,” arXiv preprint arXiv: 1312.6114, Dec. 20, 2013.

### SUMMARY

### Technical Problem

With the existing technique described above, however, when the reconstructing process becomes harder, the result of inference made through image recognition or the like on data, such as a pre-reconstruction image, may substantially deteriorate. For example, when the quality of an image output through a reconstructing process is low, this degrades the result of image recognition performed on the image output through the reconstructing process. Therefore, it is possible to say that the result of image recognition that would be obtained from the image reconstruction performed on the pre-reconstruction image may substantially deteriorate in turn.

The present disclosure provides an information processing method that makes it possible to keep the result of inference about pre-reconstruction data from substantially deteriorating even when the reconstructing process becomes harder.

### Solution to Problem

An information processing method according to one aspect of the present disclosure is a method to be executed by a computer, and the information processing method includes: obtaining first sensing data containing noise; executing first training through machine learning, the first training training a first model to output, in response to an input of sensing data containing noise, simulated sensing data that simulates sensing data to be obtained by reducing the noise in the sensing data containing the noise, and inputting the first sensing data to the first model and obtaining first feature data, the first model generating feature data of the sensing data containing the noise generated via processes leading up to output of the simulated sensing data in response to the input of the sensing data containing the noise, the first feature data being feature data of the first sensing data, the first feature data being generated via processes leading up to output of the first simulated sensing data in response to an input of the first sensing data, the first simulated sensing data being the simulated sensing data simulating the first sensing data to be obtained by reducing the noise in the first sensing data; inputting the first feature data to a second model to be subjected to second training through machine learning and obtaining first inference result data, the second training training the second model to output inference result data in response to an input of the feature data, the first inference result data being the inference result data that the second model outputs in response to an input of the first feature data; and executing the second training based on the first inference result data and reference data, the reference data being for making inference about the first sensing data.

In addition, an information processing method according to another aspect of the present disclosure is a method to be executed by a computer, and the information processing method includes: obtaining first sensing data containing noise; executing first training through machine learning, the first training training a first model to output, in response to an input of sensing data containing noise, simulated sensing data that simulates sensing data to be obtained by reducing the noise in the sensing data containing the noise, and inputting the first sensing data to the first model and obtaining first feature data, the first model generating feature data of the sensing data containing the noise generated via processes leading up to output of the simulated sensing data in response to the input of the sensing data containing the noise, the first feature data being feature data of the first sensing data, the first feature data being generated via processes leading up to output of the first sensing data in response to an input of the first sensing data, the first simulated sensing data being the simulated sensing data simulating the first sensing data to be obtained by reducing the noise in the first sensing data; inputting the first feature data to a second model to be subjected to second training through machine learning and obtaining first inference result data, the second training training the second model to output inference result data in response to an input of the feature data, the first inference result data being the inference result data that the second model outputs in response to an input of the first feature data; and outputting the first inference result data.

A non-transitory computer-readable recording medium according to another aspect of the present disclosure, the non-transitory computer-readable recording medium having recorded thereon a program that, upon executed by a processor included in a computer, causes the processor to execute in the computer: obtaining first sensing data containing noise; executing first training through machine learning, the first training training a first model to output, in response to an input of sensing data containing noise, simulated sensing data that simulates sensing data to be obtained by reducing the noise in the sensing data containing the noise, and inputting the first sensing data to the first model and obtaining first feature data, the first model generating feature data of the sensing data containing the noise generated via processes leading up to output of the simulated sensing data in response to the input of the sensing data containing the noise, the first feature data being feature data of the first sensing data, the first feature data being generated generated via processes leading up to output of the first sensing data in response to an input of the first sensing data, the first simulated sensing data being the simulated sensing data simulating the first sensing data to be obtained by reducing the noise in the first sensing data; inputting the first feature data to a second model to be subjected to second training through machine learning and obtaining first inference result data, the second training training the second model to output inference result data in response to an input of the feature data, the first inference result data being the inference result data that the second model outputs in response to an input of the first feature data; and outputting the first inference result data.

It is to be noted that general or specific embodiments of the above may be implemented in the form of an apparatus, a system, an integrated circuit, or a computer readable recording medium, such as a CD-ROM, or through any desired combination of an apparatus, a system, a method, an integrated circuit, a computer program, and a recording medium.

### Advantageous Effects

The use of the information processing method and the program according to the present disclosure makes it possible to keep the result of inference about pre-reconstruction data from deteriorating substantially even when the reconstructing process becomes harder.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a table illustrating examples of images with different image qualities and examples of results of a reconstructing process performed on these images.

FIG. 2 is a diagram for describing an overview of an information processing method according to an embodiment.

FIG. 3 is a flowchart illustrating an example of a procedure of the information processing method according to the embodiment.

FIG. 4 is a flowchart illustrating an example of a procedure of a method of training a variational autocoder in the stated information processing method.

FIG. 5 is a flowchart illustrating an example of a procedure of a method of training a recognizer in the stated information processing method.

FIG. 6 is a flowchart illustrating an example of a procedure of an image recognizing method in which a recognizer trained in the stated information processing method is used.

FIG. 7 is a diagram for describing an overview of an information processing method according to a variation of the embodiment.

FIG. 8 is a table summarizing the result of an experiment conducted by the inventor.

### DESCRIPTION OF EMBODIMENTS

### Underlying Knowledge

The present inventor found the following problem with respect to the image recognition technique described in Background Art.

An image captured by a monitoring camera or the like installed at a private home or in a public location may be subjected to image recognition for security purpose or the like. This image recognition process may be performed on image data on a cloud server after the image data has been output from the camera and uploaded to the cloud server. In this case, due to the privacy protection requirement, noise, such as blurring, may be added in advance to the image to be subjected to the image recognition process. In other words, the image recognition may need to be performed on a reduced-quality image for privacy protection purpose. Yet, such an image degraded with added noise tends to result in low image recognition accuracy. Therefore, a reconstructing process of improving the image quality by reducing the noise is performed as a preprocess to the image recognition process.

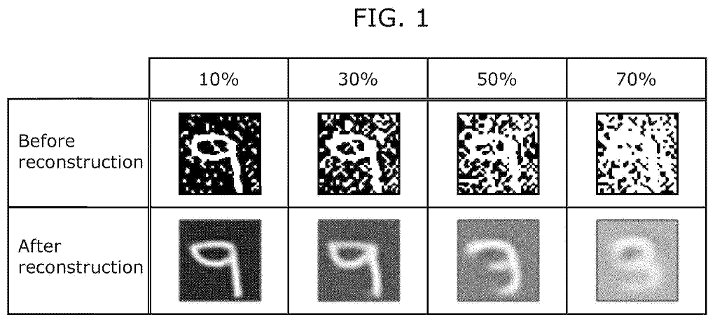

However, an image added with more intense noise so as to protect the privacy more reliably renders it harder to perform the reconstructing process thereon with high accuracy. FIG. 1 is a table illustrating examples of images added with noise at different intensity levels and examples of results of the reconstructing process performed on these images. In this example, four images obtained by adding salt-and-pepper noise at a proportion of 10%, 30%, 50%, and 70% to images capturing a handwritten digit “9” included in the Modified National Institute of Standards and Technology (MNIST) database are arranged in the upper half, and images obtained as a result of subjecting the above four images to the reconstructing process are arranged in the lower half. Such a reconstructing process can be performed by use of a model trained through machine learning for removing or reducing target noise (hereinafter, regardless of whether noise is removed or reduced as an actual effect, the term “reduce” is used). That is, for example, the reconstructing process can be performed by use of an autoencoder. In the reconstructing process in the example illustrated in FIG. 1, a convolutional autoencoder is used. With reference to FIG. 1, when the proportion of the noise is up to 30%, the images obtained through reconstruction each include the handwritten “9” that can be recognized by human vision. This allows for speculating that the appearance of the images obtained through the reconstruction is close to how the images appeared before the noise was added. In this example, since the digit “9” in the pre-reconstruction images can be recognized relatively easily with human vision, the noise at such intensity levels may not be sufficient for protecting the privacy.

Yet, a digit in a pre-reconstruction image becomes more difficult to recognize with human vision as the proportion of noise increases. In other words, if this technique is applied to a picture of a human, for example, one can expect an advantageous effect of more reliable privacy protection. However, when the proportion of the noise reaches or exceeds 50%, the overall contrast is reduced in the reconstructed images, the outlines become more blurred, and the white lines that would depict the digit “9” are partially cut off or deformed. Therefore, even if these images are subjected to image recognition, whether the image recognition can produce an accurate result is uncertain. In this manner, there is a trade-off between intensifying the noise for protecting the privacy and improving the accuracy in reconstructing the image. Accordingly, trying to increase the privacy protection may result in sacrificing the image recognition performance, and this makes it difficult to enhance the security while utilizing the image recognition result, for example.

An information processing method according to one aspect of the present disclosure conceived of in order to solve the above problem is a method to be executed by a computer. The information processing method includes obtaining first sensing data containing noise; executing first training through machine learning, the first training training a first model to output simulated sensing data in response to an input of sensing data containing noise, the simulated sensing data simulating sensing data to be obtained by reducing the noise in the sensing data containing the noise; inputting the first sensing data to the first model and obtaining first feature data, the first model generating feature data of the sensing data containing the noise generated via processes leading up to output of the simulated sensing data in response to the input of the sensing data containing the noise, the first feature data being the feature data of the first sensing data, the first feature data being generated generated via processes leading up to output of the first sensing data in response to an input of the first sensing data, the first simulated sensing data being the simulated sensing data simulating the first sensing data to be obtained by reducing the noise in the first sensing data; inputting the first feature data to a second model to be subjected to second training through machine learning and obtaining first inference result data, the second training training the second model to output inference result data in response to an input of the feature data, the first inference result data being the inference result data that the second model outputs in response to an input of the first feature data; and executing the second training based on the first inference result data and reference data that is for making inference about the first sensing data.

This method makes it possible to keep the result of inference about pre-reconstruction data from substantially deteriorating even when the reconstructing process becomes harder to perform with high accuracy. In other words, a recognition model that can exhibit higher recognition performance on noise-containing sensing data can be obtained.

The first model may include an encoder and a decoder. The encoder may output the feature data of the sensing data containing the noise in response to the input of the sensing data containing the noise. The decoder may generate the simulated sensing data in response to an input of the feature data output by the encoder and output the generated simulated sensing data. The feature data may be a latent variable. The feature data may be mean data and dispersion data of the first sensing data. The feature data may be a latent variable pertaining to a prior distribution of the first sensing data.

In this manner, the information processing method according to one aspect of the present disclosure can use, for example, intermediate data of an autoencoder or a variational autoencoder conventionally used to reduce noise in image data. Therefore, in a case where an autoencoder for reducing noise in an image is already used for image recognition, for example, an additional use of a recognizer makes it possible to construct an environment where the information processing method according to one aspect of the present disclosure is to be executed. In other words, in this case, the information processing method according to one aspect of the present disclosure can be introduced without an increase in the amount of processing and the cost of hardware. Moreover, when intermediate data of which the tendency of input data is organized (in other words, the intermediate data in which the features of the input data are represented by a predetermined structure), instead of intermediate data of a simple encoder, is input to the second model, the performance (the accuracy in particular) of the inferring process of the second model can be improved.

The first sensing data and the first simulated sensing data may be obtained, and the first training may be performed based on the first sensing data, the first simulated sensing data, and the first feature data. Moreover, retraining may be executed after the second training. The retraining may include further executing the first training, obtaining second feature data that is the feature data generated by the first model trained further, obtaining second inference result data that is the inference result data that the second model outputs in response to an input of the second feature data, and further executing the second training based on the second inference result data. Furthermore, an evaluation on an inference result by the second model indicated by the inference result data may be obtained, and the retraining may be repeated until the evaluation satisfies a predetermined standard.

It is highly likely that the performance of an estimator improves as the performance of an autoencoder improves. Therefore, the performance of the estimator is expected to improve as the estimator is trained in accordance with the training of the autoencoder as described above. Moreover, as the training of the first model through machine learning is executed in parallel, for example, the outcome of the training or the timing to stop the training can be determined by using the accuracy of the inference made by the second model as an index of the result of training of the first model.

The sensing data containing the noise may be image data.

This makes it possible to obtain a recognition model that can exhibit higher recognition performance with respect to a noise-containing, low-quality image.

In addition, an information processing method according to another aspect of the present disclosure is a method to be executed by a computer. The information processing method includes obtaining first sensing data containing noise; executing first training through machine learning, the first training training a first model to output simulated sensing data in response to an input of sensing data containing noise, the simulated sensing data simulating sensing data to be obtained by reducing the noise in the sensing data containing the noise; inputting the first sensing data to the first model and obtaining first feature data, the first model generating feature data of the sensing data containing the noise generated via processes leading up to output of the simulated sensing data in response to the input of the sensing data containing the noise, the first feature data being the feature data of the first sensing data, the first feature data being generated via processes leading up to output of the first sensing data in response to an input of the first sensing data, the first simulated sensing data being the simulated sensing data simulating the first sensing data to be obtained by reducing the noise in the first sensing data; inputting the first feature data to a second model to be subjected to second training through machine learning and obtaining first inference result data, the second training training the second model to output inference result data in response to an input of the feature data, the first inference result data being the inference result data that the second model outputs in response to an input of the first feature data; and outputting the first inference result data.

This method allows for executing recognition on noise-containing sensing data with higher accuracy.

It is to be noted that general or specific embodiments of the above may be implemented in the form of an apparatus, a system, an integrated circuit, a computer program, or a computer readable recording medium, such as a CD-ROM, or through any desired combination of an apparatus, a system, a method, an integrated circuit, a computer program, and a recording medium.

Hereinafter, an embodiment will be described in concrete terms with reference to the drawings. The embodiment described below merely illustrates a general or specific example. The numerical values, the shapes, the materials, the constituent elements, the arrangement positions and the connection modes of the constituent elements, the combinations of the steps included in the methods, the orders of the steps, and so on illustrated in the following embodiment are examples and are not intended to limit the invention according to the present disclosure.

### Embodiment

### 1. Overview

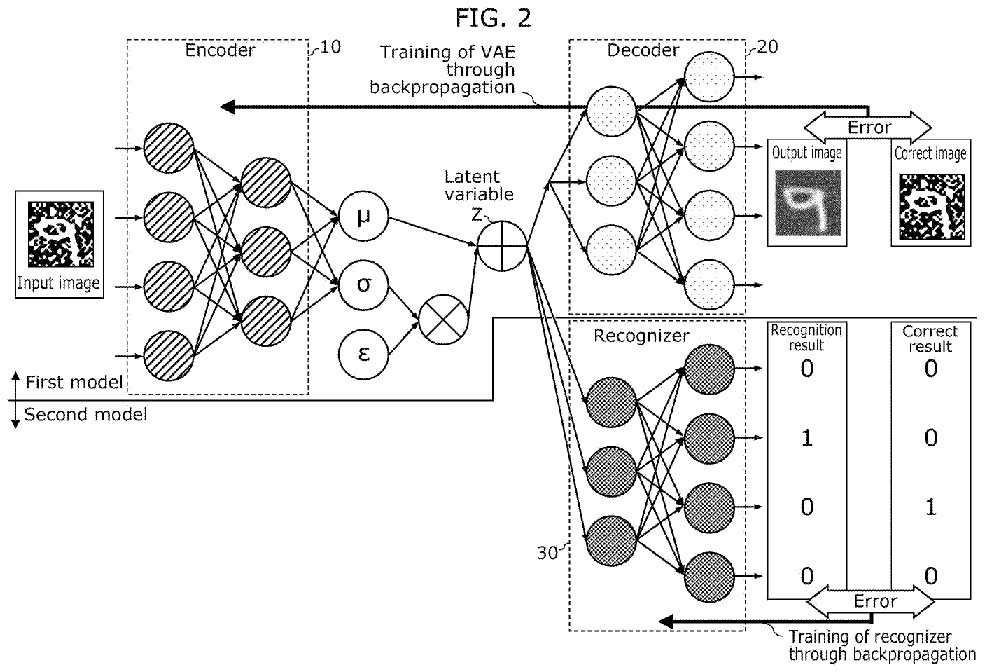

FIG. 2 is a diagram for describing an overview of an information processing method according to an embodiment. FIG. 2 illustrates an example of a configuration that includes two models for executing the information processing method, and these two models are to be implemented in one or more computers. The information processing method according to the present embodiment is executed by one or more computers each including a processor and is executed to obtain an estimation model trained through machine learning. This computer or these computers are configured such that the two models to be used to execute the information processing method can operate therein.

The one of these two models generates, from noise-containing sensing data, data that simulates sensing data to be obtained by reducing the noise in the noise-containing sensing data, and outputs the generated data. In FIG. 2, this model corresponds to a first model depicted above the line separating the upper and lower halves. In this example, the first model is a variational autoencoder (VAE) generative model. The VAE is a type of a neural network. In FIG. 2, the first model receives an input of image data as an example of sensing data.

The other of the aforementioned two models is a neural network inference model that functions as a recognizer. The recognizer receives an input of intermediate data that arises in the process performed by the first model, performs recognition through inference about the received intermediate data, and outputs the result of the recognition. In FIG. 2, this model corresponds to a second model depicted below the line separating the upper and lower halves. The intermediate data that the second model receives as an input is data representing features of the sensing data input to encoder 10. In the example illustrated in FIG. 2, this intermediate data is latent variable Z. Latent variable Z of the first model, or the VAE, is a latent distribution concerning the prior distribution of the sensing data input to encoder 10. This latent distribution can be obtained through sampling based on the mean (μ in FIG. 2) and the dispersion (σ in FIG. 2) of the multivariate Gaussian distribution where the features of the sensing data that encoder 10 has received as an input are compressed and output.

Latent variable Z obtained in this manner is input to decoder 20 in the VAE. Decoder 20 is trained to generate data (the output image illustrated in FIG. 2) simulating the noise-reduced sensing data in response to receiving latent variable Z as an input. This training will be described later. Latent variable Z is an example of feature data according to the present embodiment.

In the information processing method according to the present embodiment, the feature data is input to the second model as well. In response to receiving the feature data as an input, the second model performs recognition on the sensing data input to encoder 10. In the example illustrated in FIG. 2, the sensing data is image data of a handwritten digit, and the second model recognizes which digit this handwritten digit is based on the feature data of the image data and outputs the result of the recognition. This training of the second model through machine learning is one of the steps included in the information processing method according to the present embodiment.

When the training of the second model advances to achieve desired recognition performance, one can say that the information processing method for performing recognition on sensing data by use of encoder 10 of the first model and the second model is ready to be executed.

In FIG. 2, encoder 10, decoder 20, and recognizer 30 are each schematically depicted to have a two-layer network configuration. The network configuration of each of encoder 10, decoder 20, and recognizer 30 is a matter of design and is not limited to how they are depicted in the drawings.

### 2. Procedure

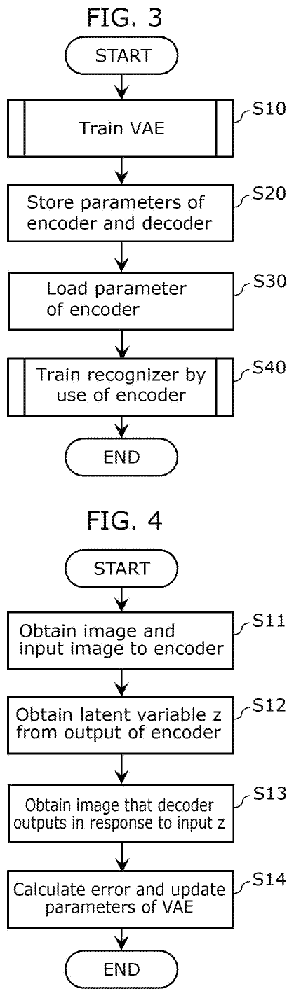

With reference to FIGS. 3 to 5 in addition to FIG. 2, some procedures of the information processing method according to the present embodiment will be described. In the examples described below, sensing data to be subjected to a recognition process is image data.

### 2.1 Overall Flow

FIG. 3 is a flowchart illustrating an example of a procedure of the information processing method according to the present embodiment. The overall flow of the information processing method executed by a computer is as follows.

(Step S10) The first model, or the VAE, is trained. This step is executed until the first model's performance of reducing noise in the sensing data reaches a predetermined level, for example.

(Step S20) Parameters of encoder 10 and decoder 20 are stored.

(Step S30) The parameters of encoder 10 are loaded.

(Step S40) The second model, or recognizer 30, is trained by use of encoder 10. This step is executed until the second model's performance of recognizing the sensing data reaches a predetermined level, for example.

### 2.2 Training of VAE

With reference to FIGS. 2 and 4, the training of the VAE at step S10 will be described in further detail. FIG. 4 is a flowchart illustrating an example of a procedure of a method of training the VAE.

First, an image is obtained, and the obtained image is input to encoder 10 (step S11). The image to be input to encoder 10 includes an image with noise and an image without noise.

Next, based on the mean and the dispersion that encoder 10 outputs in response to the input image, latent variable Z is obtained through sampling from the multivariate Gaussian distribution (step S12).

Next, latent variable Z obtained at step S12 is input to decoder 20, and an image (see the output image illustrated in FIG. 2) served by an output of decoder 20 with respect to input latent variable Z is obtained (step S13).

Lastly, a loss in the output image obtained at step S13, that is, an error between the output image output from decoder 20 and the input image input to encoder 10 is calculated through an error function, and the parameters of encoder 10 and decoder 20 are updated based on the calculated error (step S14). As this error function, a known error function used in VAEs, for example, can be used. In this example, ε in FIG. 2 represents noise to be introduced in the technique used to apply backpropagation to the training of the VAE at step S14.

This training of the VAE through machine learning is an example of first training according to the present embodiment.

### 2.3 Training of Recognizer

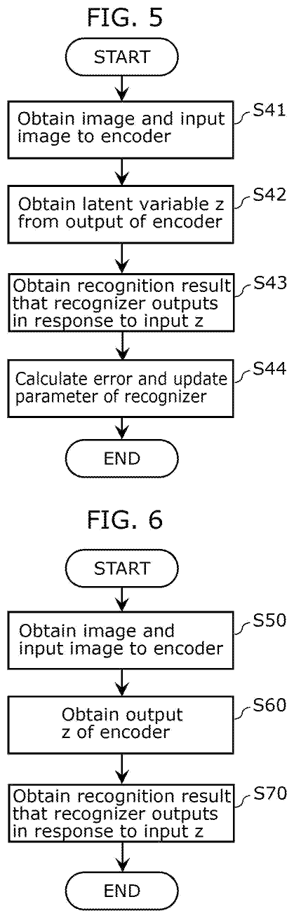

After the parameters of the VAE trained through the method described above have been stored (S20) and the parameters of encoder 10 have been loaded (S30), the training of recognizer 30 at step S40, that it, the training of the second model in the example illustrated in FIG. 2 is executed. With reference to FIGS. 2 and 5, the training of recognizer 30 will be described in further detail. FIG. 5 is a flowchart illustrating an example of a procedure of a method of training recognizer 30.

First, an image is obtained, and the obtained image is input to encoder 10 (step S41). The image to be input to encoder 10 includes an image with noise and an image without noise.

Next, based on the mean and the dispersion that encoder 10 outputs in response to the input image, latent variable Z is obtained through sampling from the multivariate Gaussian distribution (step S42).

Next, latent variable Z obtained at step S42 is input to recognizer 30, and the recognition result (see FIG. 2) served by the output of recognizer 30 with respect to input latent variable Z is obtained (step S43). In the example used to describe the present embodiment, recognizer 30 outputs the result obtained by executing recognition through inference about the digit captured in the image input to encoder 10. Recognizer 30 executes this recognition without using an input image reconstructed from the feature data (latent variable Z) indicating the features of the image input to encoder 10 or without an image obtained by removing noise from the image input to encoder 10.

Lastly, an error between the recognition result obtained at step S43 and the correct output is calculated through an error function, and the parameters of recognizer 30 are updated through backpropagation that uses the calculated error (step S44). The error used in this example can be selected as appropriate in accordance with the intended use of the recognizer. In the example used to describe the present embodiment, the cross entropy error may be used when the intended use of the recognizer is multiclass classification of classifying a digit captured in an input image into any one of 0 to 9.

The above-described training of the recognizer through machine learning is an example of second training according to the present embodiment.

### 2.4 Recapitulation of Training Method

As described above, in the information processing method according to the present embodiment, which is a method for obtaining an estimation model trained through machine learning, the first model is used. The first model is trained (the first training) through machine learning to output, in response to an input of sensing data containing noise, simulated sensing data that simulates sensing data where the noise in the input sensing data is reduced. The first model trained as described above generates feature data of the input sensing data generated via processes leading up to output of the simulated sensing data in response to the input noise-containing sensing data.

Such a first model yields feature data (first feature data) of first sensing data, and the first model generates this feature data (the first feature data) generated via processes leading up to output of first simulated sensing data that simulates the first sensing data where the noise contained in the input noise-containing first sensing data is reduced. In the foregoing description, the image input to encoder 10 of the VAE at step S41 is an example of the first sensing data, and the sensing data generated and output by decoder 20 of the VAE is an example of the first simulated sensing data. In addition, latent variable Z obtained at step S42 in the foregoing description is an example of the first feature data.

Next, the first feature data is input to the second model. In the information processing method according to the present embodiment, the second model is to be trained (the second training) through machine learning to output an inference result in response to an input of the feature data. The second model outputs data on a first inference result in response to an input of the first feature data. The recognition result output from the recognizer at step S43 in the foregoing description is an example of the first inference result.

Then, the second training is executed based on the data on the first inference result obtained from the second model and reference data (a correct output label) that is for making inference about the first sensing data.

When the second model trained in this manner is a recognizer for image recognition as in the example described above, the image recognition is executed by this recognizer without the use of a reconstructed image. In other words, the information processing method according to the present embodiment makes it possible to obtain a recognizer that is not influenced by the accuracy of image reconstruction, which tends to be affected by the amount of noise contained in an input image as illustrated in FIG. 1.

### 3. Method of Recognizing by Use of Recognizer

As with the method for obtaining the estimation model trained through machine learning described above, the recognizing method performed by use of the recognizer trained in the information processing method according to the present embodiment is an information processing method to be executed by one or more computers each including a processor. The procedure of this recognizing method substantially corresponds to the procedure of the method of training recognizer 30 excluding the step of updating the parameters by use of the error (S44 of FIG. 5). FIG. 6 is a flowchart illustrating an example of a procedure of recognizing an image by use of trained recognizer 30. Step S50 corresponds to step S41, step S60 corresponds to step S42, and step S70 corresponds to step S43. In this example, the image to be input to encoder 10 at step S50 does not need to include an image without noise, unlike at step S41. Based on the output of encoder 10 that has received an input of an image containing noise at step S50, latent variable Z representing the feature data of the input image is obtained (step S60). In response to latent variable Z obtained at step S60 being input next to trained recognizer 30, the recognition result is output from recognizer 30. That is, in the example used in the foregoing description, the result obtained by performing recognition through inference about the digit captured in the image input to encoder 10 at step S50 is output from recognizer 30 (step S70).

This recognition result is obtained without the use of an image reconstructed from the feature data (latent variable Z) representing the features of the image input to encoder 10. In other words, the recognition result is not influenced by the accuracy of image reconstruction, which tends to be affected by the amount of noise contained in an input image as illustrated in FIG. 1. Therefore, as compared to some existing techniques, the recognizing method performed by use of such a recognizer allows for performing image recognition with higher accuracy even of an image added with intense noise for enhancing the privacy protection, for example. In other words, the recognizing method can keep the result of inference about pre-reconstruction data from substantially deteriorating even with the data that is hard to reconstruct. With regard to the recognition performance obtained through this recognizing method, the result of an experiment will be presented following the variations described below.

### 4. Variations and Others

The information processing method according to one or more aspects of the present disclosure is not limited by the description of the foregoing embodiment. Unless departing from the spirit of the present disclosure, an embodiment obtained by making various modifications that a person skilled in the art can conceive of to the foregoing embodiment may also be included in an aspect of the present disclosure. In the following, some examples of such modifications and some features that supplement the description of the foregoing embodiment will be provided.

(1) In the example used to describe the foregoing embodiment, the first model is a VAE that includes an encoder and a decoder that are each a neural network model, but this is not a limiting example. In a more detailed example, the first model may be a fully connected VAE, or a VAE of network configuration, such as a conditional VAE (CVAE), a convolutional VAE (ConvVAE), or a convolutional conditional VAE (ConvCVAE, a combination of the aforementioned two VAEs), may be used as the first model. Moreover, as described above, the number of layers of each neural network can be selected as a matter of design.

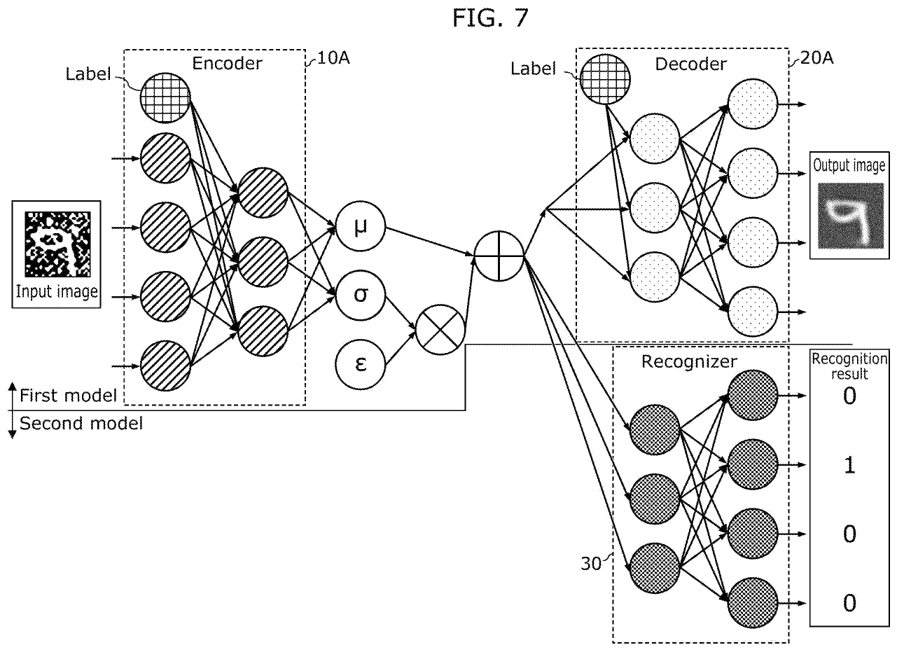

FIG. 7 illustrates an overview of an information processing method according to a variation in which the first model is a CVAE. The overview illustrated in FIG. 7 differs from the overview illustrated in FIG. 2 in that a label indicating a condition is input to each of the final layer of encoder 10A and the first layer of decoder 20A. As the label is input to encoder 10A, information other than the condition indicated by the label is extracted to latent variable Z. When the label indicating the condition is input to decoder 20A, an image corresponding to this condition can be generated from latent variable Z. For example, in response to receiving an input of a label indicating that the input image contains noise, decoder 20A generates an image containing noise from latent variable Z.

In this example, the first model may be an autoencoder (AE) instead of a VAE. In this case, as the feature data to be input to the recognizer, an output from any one of the layers selected from the encoder is used. To select a layer, a process may be performed to visualize to which features of the data input to the encoder the output of each layer corresponds, and the layer that outputs data representing the mean and the dispersion of the data input to the encoder may be selected. Alternatively, outputs from some of the layers may be input tentatively to the recognizer as the feature data, and the recognition may be executed. Then, the layer that yields more favorable recognition performance may be selected. Moreover, for example, the degree of dimensional compression from the input data at each layer or the amount of calculation may be taken into consideration in selecting a layer.

It is to be noted that a first model of what network configuration is used may be selected in accordance with the intended use of (the type of sensing data to be input to) the encoder, for example. In the foregoing embodiment, image data is used as an example of the sensing data. Alternatively, various other types of sensing data, such as audio data, acceleration data, angular speed data, distance data, or temperature data, may be input to an encoder of a VAE or an AE, and this sensing data may be subjected to certain inference through an inference model based on features extracted from the input sensing data.

(2) In the example used to describe the foregoing embodiment, noise contained in an image is salt-and-pepper noise, but this is not a limiting example. For example, such noise may be of some other type, such as a Gaussian blur. Moreover, when the sensing data is of any of the types listed above, the sensing data may include noise corresponding to the type of that sensing data.

(3) The method described according to the foregoing embodiment is an information processing method for obtaining a recognition model having higher image recognition performance with respect to a noise-added, degraded image. This information processing method can also be adopted to improve the image recognition performance with respect to a low-quality image associated with other causes. For example, such a low-quality image may be an image degraded through a compression process, an image captured by a low-performance camera, an image obtained through communication in an unfavorable communication environment, or an image recorded on a medium degraded with time. Furthermore, the information processing method according to the present disclosure can be not only applied to the recognition of image data but also used as a method of obtaining a recognition model having higher recognition performance with respect to various low-quality sensing data. As long as data in the amount required for training a model for obtaining a second model of desired performance and the correct output information can be secured, a recognition model having higher recognition performance can be obtained through the information processing method according to the present disclosure.

(4) Only the information processing method in which the first training and the second training are performed in this order has been described according to the foregoing embodiment, but this is not a limiting example. As the performance of the first model improves, the performance of the second model may also improve. In light of this, retraining including the first training and the second training may be further executed after the second training. In the retraining, feature data (second feature data) is obtained from the first model that has undergone the first training again. Then, the second feature data is input to the second model, or the recognizer, and second inference result data is output from the second model. The second inference result data is the data on the result of inference about the second feature data. Thereafter, the second training is further executed based on the second inference result data and the reference data.

Yet, the training performed by use of the feature data derived from the first model of a higher reconstruction accuracy does not necessarily yield a recognizer with higher performance. Therefore, during the process of the procedure illustrated in FIG. 3, for example, the procedure may tentatively be shifted to the procedure described below after the training of a predetermined amount has been executed at step S10, and the evaluation of the recognition result (the recognition performance) of the second model may be obtained. Then, whether to repeat the retraining further may be determined based on how this evaluation compares to a predetermined standard. For example, the cycle including the series of procedures illustrated in FIG. 3 may be repeated until a certain criterion is met. Examples of such a criterion include that the rate of correct recognition as the evaluation reaches a predetermined level or that the rate of improvement in the rate of correct output with respect to the increase in the amount of training falls below a predetermined level. In evaluating the recognition performance, the accuracy, the rate of detection, or the F-value may also be used, aside from the rate of correct output.

(5) A part or the whole of the functional constituent elements included in the foregoing information processing system may be constituted by a single system large scale integration (LSI). A system LSI is an ultra-multifunctional LSI manufactured by integrating a plurality of components on a single chip, and is, in particular, a computer system including a microprocessor, a read-only memory (ROM), and a random-access memory (RAM). The ROM stores a computer program. The microprocessor operates in accordance with this computer program, and thus the system LSI implements the functions of the constituent elements.

Although the term the system LSI is used above, depending on the difference in the degree of integration, it may also be called an IC, an LSI, a super LSI, or an ultra LSI. The technique for circuit integration is not limited to the LSI, and an integrated circuit may be implemented by a dedicated circuit or a general purpose processor. A field programmable gate array (FPGA) that can be programmed after the LSI is manufactured or a reconfigurable processor in which the connection or the setting of the circuit cells within the LSI can be reconfigured may also be used.

Furthermore, when a technique for circuit integration that replaces the LSI appears through the advancement in the semiconductor technology or through a derived different technology, the functional blocks may be integrated by using such a different technology. An application of biotechnology, for example, is a possibility.

(6) One aspect of the present disclosure is not limited to the information processing method described above with reference to the flowcharts, and one aspect of the present disclosure may be a program to be executed by a computer or an information processing system that includes a computer. Furthermore, one aspect of the present disclosure may be a non-transitory computer readable recording medium that has such a computer program recorded thereon.

### 5. Example

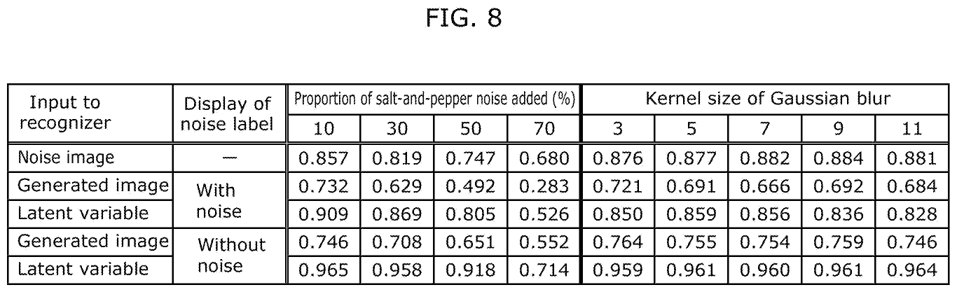

The present inventor has conducted an experiment for confirming the recognition performance of the recognizer obtained through the information processing method described thus far. FIG. 8 is a table summarizing the result of this experiment.

In this experiment, training was performed through machine learning by use of image data of handwritten digits of MNIST added with noise as well as image data of handwritten digits with no added noise. Two types of noise, namely salt-and-pepper noise and a Gaussian blur, were added to the image data, and each type of noise was added at varying intensity levels. Sixty thousand pieces of such image data were used in the training, and ten thousand pieces of such image data were subjected to recognition and evaluation.

A CVAE was used as the first model, and the label indicating the presence or the absence of the noise in the corresponding input image was used during the training. Two types of recognizers were prepared. The one type of the recognizer was of a conventional model, that is, recognized a digit from a reconstructed image output from a decoder. The other type of the recognizer was of a model trained by use of the information processing method according to the present disclosure, that is, corresponded to the second model that recognized a digit in response to an input of the latent variable of the CVAE. The column with the heading “display of noise label” in the table shows the display of the label input to the encoder during the recognition. In other words, when the display of the label says “without noise”, this label does not match the actual state of the input image.

For the purpose of reference, a recognition model that was composed of three fully connected layers and performed ten-class classification was also prepared as a recognizer that executed the recognition directly from an image containing noise, that is, from an image input to the encoder in the aforementioned CVAE.

The table in FIG. 8 shows the rate of correct output by each of the recognizers described above under each condition. The result reveals the following.

(i) Regardless of the type of the noise or the type of the recognizer, the rate of correct output tended to be lower as the intensity level of the noise was higher.

(ii) The rate of correct output was higher in the recognition from the latent variable, that is, the recognition performed by the model trained through the information processing method according to the present disclosure (the third row and the fifth row of the data rows) than in the recognition from a noise image (the first row of the data rows) and in the recognition from a generated image (the second row and the fourth row of the data rows).

(iii) In particular, with respect to the image data with salt-and-pepper noise, the decrease in the recognition performance was smaller even when the intensity level of the noise was raised in the model trained through the information processing method according to the present disclosure than in the other models.

(iv) For both the recognition from the latent variable and the recognition from a generated image, the rate of correct output was higher when the display of the label said “without noise” than when the display of the label said “with noise”.

Based on (ii) above, it was confirmed that the performance of the recognizer obtained by use of the information processing method according to the present disclosure was higher than the performance of the recognizer obtained through an existing technique.

Moreover, a possible explanation for (iv) above is that inputting the label indicating “without noise” may make it easier to extract image features corresponding to those observed when no noise is present even in a case where an image containing noise is input.

### INDUSTRIAL APPLICABILITY

The information processing method according to the present disclosure can be used in the recognition process of sensing data.

1. An information processing method to be executed by a computer, the information processing method comprising:
obtaining first sensing data containing noise;
executing first training through machine learning, the first training training a first model to output, in response to an input of sensing data containing noise, simulated sensing data that simulates sensing data to be obtained by reducing the noise in the sensing data containing the noise, and inputting the first sensing data to the first model and obtaining first feature data, the first model generating feature data of the sensing data containing the noise generated via processes leading up to output of the simulated sensing data in response to the input of the sensing data containing the noise, the first feature data being feature data of the first sensing data, the first feature data being generated via processes leading up to output of the first simulated sensing data in response to an input of the first sensing data, the first simulated sensing data being the simulated sensing data simulating the first sensing data to be obtained by reducing the noise in the first sensing data;
inputting the first feature data to a second model to be subjected to second training through machine learning and obtaining first inference result data, the second training training the second model to output inference result data in response to an input of the feature data, the first inference result data being the inference result data that the second model outputs in response to an input of the first feature data; and
executing the second training based on the first inference result data and reference data, the reference data being for making inference about the first sensing data.

2. The information processing method according to claim 1, wherein
the first model includes an encoder and a decoder,
the encoder outputs the feature data of the sensing data containing the noise in response to the input of the sensing data containing the noise,
the decoder generates the simulated sensing data in response to an input of the feature data output by the encoder and outputs the simulated sensing data, and
the feature data is a latent variable.

3. The information processing method according to claim 1, wherein
the feature data is mean data and dispersion data of the first sensing data.

4. The information processing method according to claim 1, wherein
the feature data is a latent variable pertaining to a prior distribution of the first sensing data.

5. The information processing method according to claim 1, wherein
the first sensing data and the first simulated sensing data are obtained, and
the first training is performed based on the first sensing data, the first simulated sensing data, and the first feature data.

6. The information processing method according to claim 5, further comprising:
executing retraining after the second training, wherein
the retraining includes:
further executing the first training;
obtaining second feature data, the second feature data being feature data generated by the first model trained further;
obtaining second inference result data, the second inference result data being inference result data that the second model outputs in response to an input of the second feature data; and
further executing the second training based on the second inference result data.

7. The information processing method according to claim 6, wherein
an evaluation on an inference result by the second model is obtained, the inference result being indicated by the inference result data, and
the retraining is repeated until the evaluation satisfies a predetermined standard.

8. The information processing method according to claim 1, wherein
the sensing data containing the noise is image data.

9. An information processing method to be executed by a computer, the information processing method comprising:
obtaining first sensing data containing noise;
executing first training through machine learning, the first training training a first model to output, in response to an input of sensing data containing noise, simulated sensing data that simulates sensing data to be obtained by reducing the noise in the sensing data containing the noise, and inputting the first sensing data to the first model and obtaining first feature data, the first model generating feature data of the sensing data containing the noise generated via processes leading up to output of the simulated sensing data in response to the input of the sensing data containing the noise, the first feature data being feature data of the first sensing data, the first feature data being generated via processes leading up to output of the first sensing data in response to an input of the first sensing data, the first simulated sensing data being the simulated sensing data simulating the first sensing data to be obtained by reducing the noise in the first sensing data;
inputting the first feature data to a second model to be subjected to second training through machine learning and obtaining first inference result data, the second training training the second model to output inference result data in response to an input of the feature data, the first inference result data being the inference result data that the second model outputs in response to an input of the first feature data; and
outputting the first inference result data.

10. A non-transitory computer-readable recording medium, having recorded thereon a program that, upon executed by a processor included in a computer, causes the processor to execute in the computer:
obtaining first sensing data containing noise;
executing first training through machine learning, the first training training a first model to output, in response to an input of sensing data containing noise, simulated sensing data that simulates sensing data to be obtained by reducing the noise in the sensing data containing the noise, and inputting the first sensing data to the first model and obtaining first feature data, the first model generating feature data of the sensing data containing the noise generated via processes leading up to output of the simulated sensing data in response to the input of the sensing data containing the noise, the first feature data being feature data of the first sensing data, the first feature data being generated generated via processes leading up to output of the first sensing data in response to an input of the first sensing data, the first simulated sensing data being the simulated sensing data simulating the first sensing data to be obtained by reducing the noise in the first sensing data;
inputting the first feature data to a second model to be subjected to second training through machine learning and obtaining first inference result data, the second training training the second model to output inference result data in response to an input of the feature data, the first inference result data being the inference result data that the second model outputs in response to an input of the first feature data; and
outputting the first inference result data.
